(19) United States
(12) Patent Application Publication
(10) Pub. No.: US 2025/0078004 A1
(43) Pub. Date: Mar. 6, 2025

(54) METHOD AND SYSTEM FOR DETERMINING APPROACH AND SCOPE OF HUMAN FACTORS EVALUATION FOR MEDICAL DEVICES

(71) Applicant: HCL Technologies Limited, New Delhi, ND (US)

(72) Inventor: AMEY MUKUND SHUKLA, Bangalore (IN)

(21) Appl. No.: 18/510,715

(22) Filed: Nov. 16, 2023

(30) Foreign Application Priority Data
Sep. 6, 2023 (IN) 202311059962

(51) Int. Cl. G06Q 10/0637; G06F 8/71

(52) U.S. Cl. CPC G06Q 10/0637; G06F 8/71

(57) ABSTRACT

This disclosure relates to a system and method for determining approach and scope of HF evaluation for medical devices. The method includes receiving input information related to medical device. The input information includes product launch information, change history file, HF evaluation documentation of the medical device and similar devices. The method further includes extracting the product launch information from the input information; analysing the change history file to identify changes in medical device interface and usability; classifying each of the versions of the medical device as one of a legacy device or a new device; identifying a base version for documentation and subsequent versions till date for the medical device interface; determining an HF evaluation approach for each versions of the medical device interface; performing a gap analysis for the base version and the subsequent version to identify documentation-related gaps; and determining a scope and plan for HF evaluation activities.

### TECHNICAL FIELD

This disclosure relates generally to human factors evaluation, and more particularly to a system and method for determining approach and scope of human factors evaluation for medical devices.

### BACKGROUND

The field of medical device design and development has evolved significantly in recent years, with a growing emphasis on user-centered design and usability. Ensuring that medical devices are safe, effective, and user-friendly is of utmost importance to both manufacturers and regulatory bodies. One crucial aspect of achieving this goal is to conduct thorough Human Factors (HF) Evaluation as part of the design and development process.

The International Electrotechnical Commission (IEC) 62366 Standards has emerged as a pivotal guideline for incorporating human factors engineering into the design of medical devices. These standards provide a comprehensive framework for evaluating and mitigating potential use-related hazards and ensuring that medical devices are intuitive and safe for use by healthcare professionals and patients.

While the IEC 62366 standards provide valuable guidelines, the process of determining the appropriate approach and scope for conducting HFE may be complex and challenging. Manufacturers often encounter scenarios where medical devices do not fit neatly into either the new device evaluation or legacy device evaluation categories outlined in the standards. The lack of a structured and standardized process for assessing the appropriate HFE approach may result in uncertainty, regulatory non-compliance, and delays in product launches. The existing systems fail to provide a defined process that assists manufacturers in navigating the intricate terrain of selecting the most suitable HFE approach for their medical devices.

Therefore, in order to provide solutions to the aforementioned drawback, there exists a need to develop a technique that provides a clear, systematic, and efficient process for manufacturers to identify an appropriate HFE approach based on available information, historical data, and product specifications. By integrating the proposed technique into the medical device design and development lifecycle, manufacturers may enhance the overall quality, usability, and safety of their products, while adhering to regulatory requirements.

### SUMMARY

In one embodiment, a method for determining approach and scope of human factors (HF) evaluation for medical devices is disclosed. In one example, the method may include receiving input information related to a medical device via a Graphical User Interface (GUI). The input information may include product launch information, change history file, human factors evaluation documentation of the medical device and similar devices. The method may further include extracting the product launch information from the input information. The method may further include analysing the change history file to identify one or more changes in medical device interface and medical device usability. The method may further include classifying each of the one or more versions of the medical device as one of a legacy device or a new device based on the extracted product launch information and the change history file analysis. The method may further include identifying a base version for documentation and subsequent versions till date for the medical device interface. The method may further include determining an HF evaluation approach for each of versions of the medical device interface based on the classification, the HF evaluation documentation, and incremental documentation requirement of the subsequent versions of the medical device interface. The method may further include performing a gap analysis for the base version and the subsequent version to identify documentation-related gaps. The method may further include determining a scope and plan corresponding to the version for HF evaluation activities based on the determined approach, and the identified documentation-related gaps.

In another embodiment, a Graphical User Interface (GUI) client on a computing device for determining approach and scope of human factors evaluation for medical devices is disclosed. The GUI client may be configured to receive input information related to a medical device. The input information may include product launch information. The GUI client may further be configured to render a change history file based on the product launch information. The GUI client may further be configured to receive Human Factor (HF) evaluation documentation of a base version of the medical device. For each version from the base version to latest version of the medical device, the GUI client may further be configured to render the scope and plan corresponding to the version to the computing device.

In yet another embodiment, a system for determining approach and scope of human factors (HF) evaluation for medical devices is disclosed. In one example, the system may include a processor and a memory communicatively coupled to the processor, wherein the memory stores processor-executable instructions, which, on execution, may cause the processor to receive input information related to a medical device via a Graphical User Interface (GUI). The input information may include product launch information, change history file, human factors evaluation documentation of the medical device and similar devices. The processor-executable instructions, on execution, may further cause the processor to extract the product launch information from the input information. The processor-executable instructions, on execution, may further cause the processor to analyse the change history file to identify one or more changes in medical device interface and medical device usability. The processor-executable instructions, on execution, may further cause the processor to classify each of the one or more versions of the medical device as one of a legacy device or a new device based on the extracted product launch information and the change history file analysis. The processor-executable instructions, on execution, may further cause the processor to identify a base version for documentation and subsequent versions till date for the medical device interface. The processor-executable instructions, on execution, may further cause the processor to determine an HF evaluation approach for each of versions of the medical device interface based on the classification, the HF evaluation documentation, and incremental documentation requirement of the subsequent versions of the medical device interface. The processor-executable instructions, on execution, may further cause the processor to perform a gap analysis for the base version and the subsequent version to identify documentation-related gaps. The method may further include determining a scope and plan corresponding to the version for HF evaluation activities based on the determined approach, and the identified documentation-related gaps.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is an environment of a system for determining approach and scope of human factors evaluation for medical devices, in accordance with some embodiments of the present disclosure.

FIG. 2 illustrates a block diagram of various modules configured for determining approach and scope of human factors evaluation for medical devices, in accordance with some embodiments of the present disclosure.

FIG. 3 is a flowchart of a method for determining approach and scope of human factors evaluation for medical devices, in accordance with some embodiments of the present disclosure.

FIG. 4 illustrates a Graphical User Interface (GUI) rendered on a computing device, in accordance with an exemplary embodiment of the present disclosure.

FIG. 5 is a block diagram of an exemplary computer system for implementing embodiments consistent with the present disclosure.

### DETAILED DESCRIPTION

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the invention is not intended to be limited to the embodiments shown but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to be one of ordinary skill in the art. Additionally, memory or other storage, as well as communication components, may be employed in embodiments of the invention.

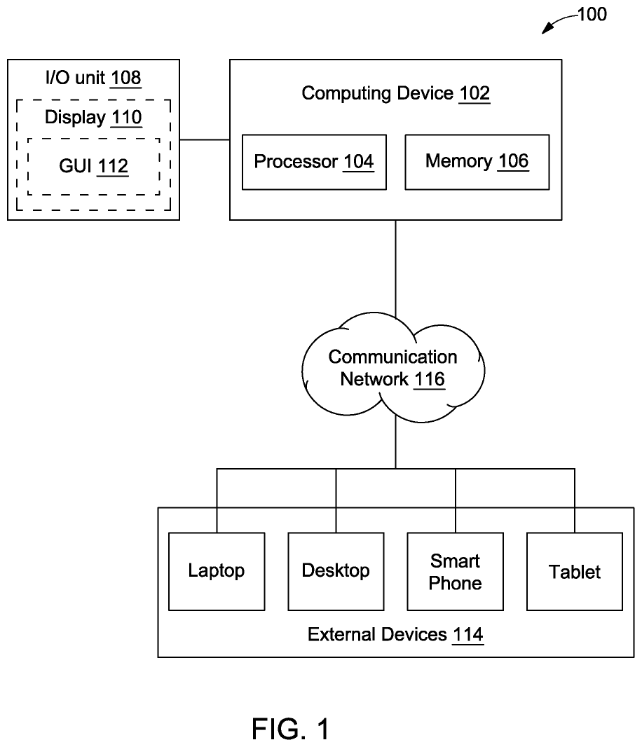

Referring now to FIG. 1, is an environment diagram illustrating a system 100 for determining approach and scope of human factors (HF) evaluation for medical devices is illustrated, in accordance with some embodiment of the present disclosure. The system 100 includes a computing device 102 that may be capable of determining most suitable approach and scope for performing HF evaluation of medical as per medical device regulatory standards (for example, IEC 62366 standards).

The IEC 62366 standards represent a critical guideline that outlines the principles of applying human factors engineering to the design and evaluation of medical devices to mitigate potential use-related hazards and enhance usability. Examples of the computing device 102 may include, but are not limited to, a server, a desktop, a laptop, a notebook, a tablet, a smartphone, a mobile phone, an application server, or the other computing devices.

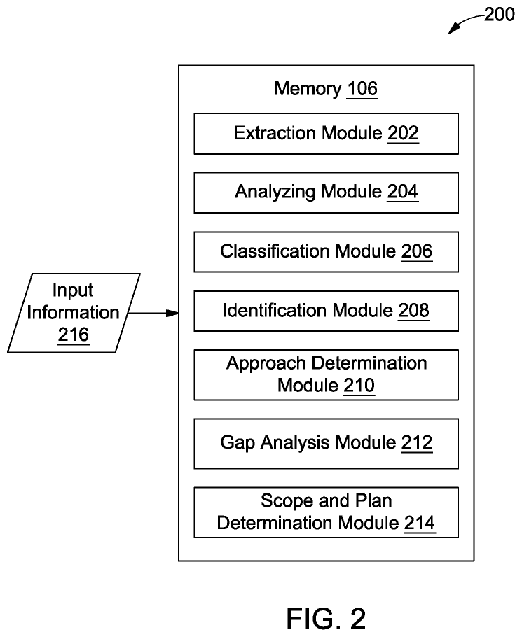

As will be described in greater detail in conjunction with FIG. 2 to FIG. 5, in order to determine suitable approach and scope for HF evaluation, initially the computing device 102 may receive input information related to the medical device. The input information may include product launch information, change history file, human factors evaluation documentation of the medical device and similar devices. Further, the computing device 102 may extract the product launch information from the input information. Thereafter, the computing device 102 may analyse the change history file to identify one or more changes in medical device interface and medical device usability. Further, the computing device 102 may classify each of the one or more versions of the medical device as one of a legacy device or a new device based on the extracted product launch information and the change history file analysis. Further, the computing device 102 may identify a base version for documentation and subsequent versions till date for the medical device interface. Further, the computing device 102 may determine an HF evaluation approach for each of versions of the medical device interface based on the classification, the HF evaluation documentation, and incremental documentation requirement of the subsequent versions of the medical device interface. Further, the computing device 102 may perform a gap analysis for the base version and the subsequent version to identify documentation-related gaps. Further, the computing device 102 may determine a scope and plan corresponding to the version for HF evaluation activities based on the determined approach, and the identified documentation-related gaps.

The computing device 102 include a processor 104 that is communicatively coupled to a memory 106 which may be a non-volatile memory or a volatile memory. Examples of non-volatile memory may include, but are not limited to a flash memory, a Read Only Memory (ROM), a Programmable ROM (PROM), Erasable PROM (EPROM), and Electrically EPROM (EEPROM) memory. Examples of volatile memory may include but are not limited to Dynamic Random Access Memory (DRAM), and Static Random-Access Memory (SRAM).

The memory 106 may store instructions that, when executed by the processors 104, cause the processor 104 to determine approach and scope of HF evaluation for medical devices. As will be described in greater detail in conjunction with FIG. 2 to FIG. 5, in order to determine approach and scope, the processor 104 in conjunction with the memory 106 may perform one or more functions.

The memory 106 may also store various data (e.g., product launch information, change history file, design history files, or technical files, human factors evaluation documentation, configuration settings, etc.) that may be captured, processed, and/or required by the computing device 102. The memory 106 may further include various modules that enable the computing device 102 to determine approach and scope of HF evaluation for medical devices. These modules are explained in detail in conjunction with FIG. 2.

The computing device 102 may interact with a user via an input/output unit 108. In particular, the computing device 102 may interact with the user via a graphical user interface (GUI) 112 accessible via the display 110. Thus, for example, in some embodiments, the GUI 112 may enable the user to input information related to the medical device via the GUI 112, configure evaluation parameters, and make decisions regarding the evaluation process. Further, in some embodiments, the computing device 102 may render results (e.g., evaluation reports, compliance status, etc.) to the end-user via the user interface 112.

The system 100 may also include one or more external devices 114. In some embodiments, the computing device 102 may interact with the one or more external devices 114 over a communication network 116 for sending or receiving various data. For example, in one embodiment the computing device 102 may interact with the one or more external devices 114 for receiving input documents, templates, standard operating procedures, work instructions and other forms of data (e.g., notes, pictures, recordings etc., for the evaluations performed earlier) from a customer. In other embodiment, the computing device 102 may interact with the one or more external devices 114 to send the scope and plan corresponding to the version for HF evaluation activities based on the determined approach, and the identified documentation-related gaps.

Examples of the external devices 114 may include, but are not limited to, computer, tablet, smartphone, and laptop. The communication network 116, for example, may be any wired or wireless network and the examples may include, but may be not limited to, the Internet, Wireless Local Area Network (WLAN), Wi-Fi, Long Term Evolution (LTE), Worldwide Interoperability for Microwave Access (WiMAX), and General Packet Radio Service (GPRS).

Referring now to FIG. 2, is a block diagram 200 of various modules within the memory 106 of the computing device 102 configured for determining approach and scope of HF evaluation for medical devices is illustrated, in accordance with some embodiments of the present disclosure. The block diagram 200 may include an extraction module 202, an analyzing module 204, a classification module 206, an identification module 208, an approach determination module 210, a gap analysis module 212, and a scope and plan determination module 214.

In order to determine the approach and scope for HF evaluation of medical devices, initially the computing device 102 may receive input information 216 related to the medical device from a customer (e.g., internal and/or external customer). The input information may include product launch information, change history file, human factors evaluation documentation of the medical device, and similar device.

In a more elaborative way, the computing device 102 may receive input documents, templates, standard operating procedures, work instructions and other forms of data (e.g., notes, pictures, recordings etc. for the HF evaluations performed earlier if any) from internal or external customers. It should be noted that the other forms of data may be product specific HF evaluation related documentation (e.g., design history files, or technical files) available for the product considered for the evaluation or for a similar older and/or predicate devices.

Once the input information is received, the extraction module 202 may be responsible for extracting the product launch information from the input information. The product launch information may include information corresponding to one or more versions of the medical device, and a launch date and change information of each of the one or more versions.

The extraction module 202 specifically focuses on retrieving details about the product strategy, which may involve launching various versions of the medical device with specific changes or improvements along with launch dates of different product interfaces, such as hardware and software, for the medical devices. As will be apparent to a person skill in the art, the extraction module 202 may utilize various techniques, including but not limited to, manual extraction techniques, computer-based data extraction techniques, or AI-assisted extraction techniques for extracting the product launch information.

The analyzing module 204 may analyze the change history file to identify one or more changes in medical device interface and medical device usability. The primary objective of the analyzing module 204 is to examine historical changes the medical device has undergone, specifically focusing on different aspects, such as hardware, software, packaging, labeling, Instructions for Use (IFU)/user manuals, and trainings. These elements may collectively contribute to how users interact with the medical device under evaluation.

More particularly, the analyzing module 204 may evaluate these changes to identify any modifications that have impacted the usability of the medical device. By studying these changes in various components and interfaces of the medical device, the analyzing module 204 may pinpoint specific areas where changes have a potential to influence user experience and usability. These areas are critical for making informed decisions about the appropriate approach and scope for HF evaluation activities.

Based on the extracted product launch information and the change history file analysis, the classification module 206 may classify each version of the medical device as either a legacy device or a new device. The classification of the medical device as either the legacy device or the new device may be based on the date it was launched and a predefined date derived from regulatory standards (specifically referencing IEC 62366 Standards).

More specifically, if a version of the medical device was launched before the predefined date, which is determined by the regulatory standards for human factors and usability (such as IEC 62366 Standards), that version is classified as the legacy device. Similarly, if a version of the medical device was launched after the predefined date, it is classified as the new device.

To provide a specific example, according to IEC 62366 Standards, products launched before February 2015 are considered legacy devices, while products launched on or after February 2015 are considered new devices. This classification helps distinguish between older versions that may have been developed before the more stringent human factors and usability standards were in place (legacy devices) and newer versions developed under the updated standards (new devices).

The identification module 208 may be responsible for identifying a base version for documentation purposes and subsequent versions till date for the medical device interface. It ensures that the HF evaluation process takes into account the entire history of the medical device development.

The approach determination module 210 may determine the HF evaluation approach for each version of the medical device interface based on the classification, the HF evaluation documentation, and incremental documentation requirement of the subsequent versions of the medical device interface. The approach determination module 210 may decide whether the approach should be tailored differently based on whether the version is the legacy device or the new device.

The gap analysis module 212 may perform a gap analysis to identify any gaps in the documentation related to HF evaluation for the base version and subsequent versions of the medical device. It may highlight areas where further documentation or compliance actions may be needed to meet regulatory requirements.

The scope and plan determination module 214 may be configured to determine a scope and plan for HF evaluation activities for each version of the medical device. It considers the determined approach, the identified gaps from the gap analysis, and specifies the necessary actions to ensure that HF evaluation is carried out effectively. This may include creating or updating documentation, conducting specific usability tests, addressing identified gaps in existing documentation, and ensuring the medical device usability aligns with regulatory standards set by IEC 62366.

Once the scope and plan are determined, the scope and plan corresponding to the version may be rendered to the computing device through the GUI. In particular, a summarized report of the determined scope and plan may be created and visually presented to the user. The summarize report may include details of the gaps identified in the existing documentation and the human factors evaluation activities that are required to be performed on the medical devices. It should be noted that the GUI is the interface through which the user interacts with the computing device.

It should be noted that all such aforementioned modules 202-214 may be represented as a single component or a combination of different components. Further, as will be appreciated by those skilled in the art, each of the modules 202-214 may reside, in whole or in parts, on one device or multiple devices in communication with each other. In some embodiments, each of the modules 202-214 may be implemented as dedicated hardware circuit comprising custom application-specific integrated circuit (ASIC) or gate arrays, off-the-shelf semiconductors such as logic chips, transistors, or other discrete components. Each of the modules 202-214 may also be implemented in a programmable hardware device such as a field programmable gate array (FPGA), programmable array logic, programmable logic device, and so forth. Alternatively, each of the modules 202-214 may be implemented in software for execution by various types of microcontrollers (e.g., processor 104). An identified component of executable code may, for instance, include one or more physical or logical blocks of computer instructions, which may, for instance, be organized as an object, procedure, function, or other construct. Nevertheless, the executables of an identified component need not be physically located together but may include disparate instructions stored in different locations which, when joined logically together, include the component and achieve the stated purpose of the component. Indeed, a component of executable code could be a single instruction, or many instructions, and may even be distributed over several different code segments, among different applications, and across several memory devices.

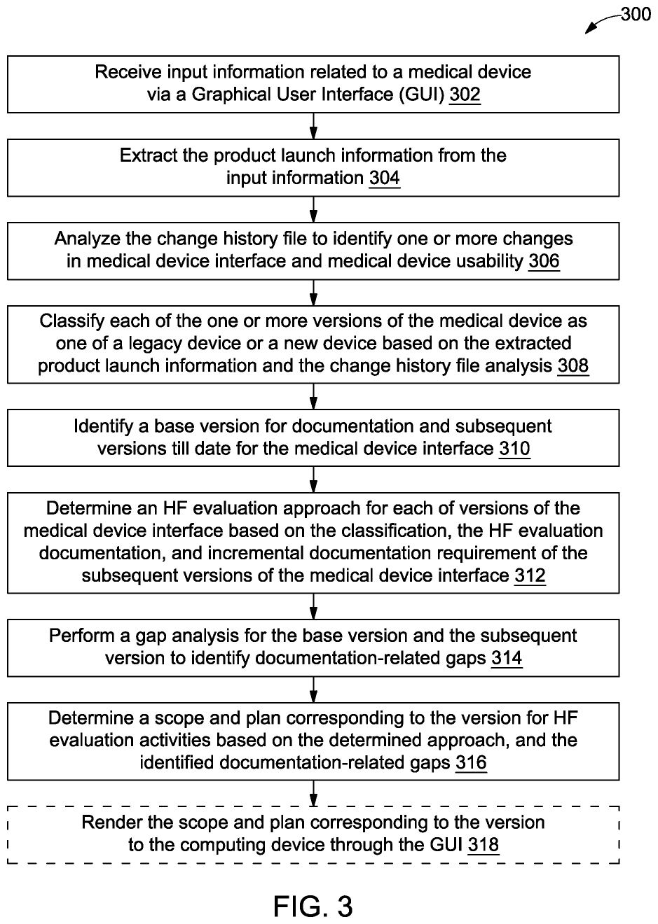

Referring now to FIG. 3, a flowchart of a method 300 for determining approach and scope of human factors evaluation for medical devices is illustrated, in accordance with some embodiments of the present disclosure. It should be noted that all the steps 302-318 may be executed by the modules 202-214. At step 302, input information related to a medical device may be received. The input information may include product launch information, change history file, human factors evaluation documentation of the medical device and similar devices. It should be noted that the input information may be received via the GUI 112.

Once the input information is received, further at step 304, the product launch information may be extracted from the input information. The product launch information may include information corresponding to one or more versions of the medical device, and a launch date and change information of each of the one or more versions.

At step 306, the change history file may be analysed to identify one or more changes in medical device interface and medical device usability. The change history file may include impact of change information anticipated for an interface of the medical device.

At step 308, each of the one or more versions of the medical device may be classified as one of a legacy device or a new device based on the extracted product launch information and the change history file analysis.

It should be noted that the medical device may be classified as the legacy device when the launch date of a version of the medical device is prior to the predefined date. Additionally, the medical device may be classified as the new device when the launch date of the version of the medical device is after the predefined date. The predefined date may be as per a set of medical device regulatory standards for human factors and usability (for example, as per IEC 62366 standards).

At step 310, a base version for documentation and subsequent versions may be identified till date for the medical device interface. In some embodiments, the base version of the medical device may also be identified. This may be important for establishing a clear reference point for the evaluation activities. The base version often represents a version with a stable and well-established design that serves as a basis for further development.

At step 312, an HF evaluation approach may be determined for each of versions of the medical device interface based on the classification, the HF evaluation documentation, and incremental documentation requirement of the subsequent versions of the medical device interface.

At step 314, a gap analysis may be performed for the base version and the subsequent version to identify documentation-related gaps. The primary objective of the gap analysis may be to identify any gaps or shortcomings in the documentation related to HF evaluation. These gaps may include missing information, incomplete documentation, or areas where compliance with regulatory requirements is lacking.

At step 316, a scope and plan corresponding to the version may be determined for HF evaluation activities based on the determined approach, and the identified documentation-related gaps.

In a more elaborative way, the determination of the scope and plan may be based on two key factors i.e., the approach chosen for HF evaluation, which was determined earlier, and the documentation-related gaps identified during the gap analysis. The scope and plan outline the specific actions, procedures, and tasks that need to be executed to ensure effective HF evaluation, regulatory compliance, and usability enhancement.

Once the scope and plan are determined, the scope and plan may further be rendered to the computing device 102 through the GUI, at step 318. This step ensures that the user has access to the details of the planned HF evaluation activities, making it clear what steps need to be taken for each version of the medical device.

In some embodiments, the approach and scope of HF evaluation for medical devices is determined by a GUI client present on the computing device 102. The GUI client may be a software interface that runs on the computing device 102. It facilitates user interaction and decision-making by providing a user-friendly environment.

Therefore, in order to determine the approach and scope of HF evaluation for medical devices through the GUI client, initially, the GUI client may receive input information related to a medical device. The input information may include product launch information.

Further, the GUI client may be configured to render a change history file based on the product launch information. Further, the GUI client may receive HF evaluation documentation of a base version of the medical device. For each version from the base version to latest version of the medical device, the GUI client may further be configured to render the scope and plan corresponding to the version to the computing device.

As will be appreciated by one skilled in the art, a variety of processes may be employed for determining approach and scope of HF evaluation for medical devices. For example, the system 100 and the associated computing device 102 may determine approach and scope by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more microcontrollers on the system 100 to perform some or all of the techniques described herein. Similarly, application specific integrated circuits (ASICs) configured to perform some, or all of the processes described herein may be included in the one or more microcontrollers on the system 100.

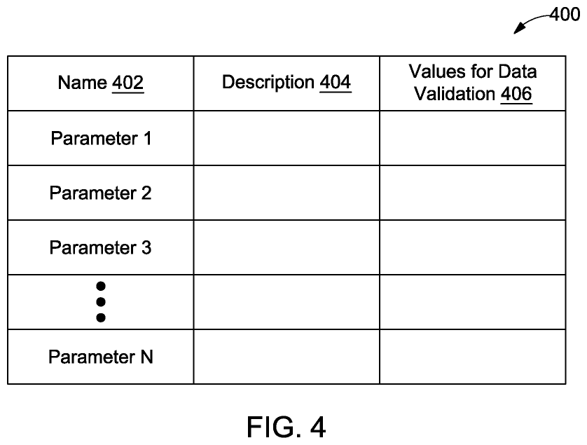

Referring now to FIG. 4 is a GUI 400 rendered on the computing device 102, in accordance with an exemplary embodiment of the present disclosure. The GUI 400 may be rendered for the purpose of presenting the scope and plan on the computing device 102. The GUI 400 may include three main columns: parameter name 402, description 404, and values for data validation 406. The GUI 400 is designed to visually display the information and parameters relevant to evaluating compliance with usability engineering and medical device regulations. The parameter name 402 may include a plurality of parameters (e.g., parameter 1, parameter 2, parameter 3 . . . parameter N). These parameters are preferably a checklist that may provide a structured approach for evaluating compliance with usability engineering and medical device regulations, making sure that all relevant aspects are assessed and documented in a systematic manner.

By way of an example, the plurality of parameters may be, but not be limited to, clause/section, requirements, input type (applicable only for ‘EN 62366-1 Checklist’ tab and ‘EN 62366-1 Annex C Checklist’ tab), requirement category (Applicable only for ‘EN 62366-1 Checklist’ tab and ‘EN 62366-1 Annex C Checklist’ tab), applicability of usability engineering (applicable only for ‘MDR-Annex I checklist’ tab and ‘MDR-Annex II Checklist’ tab) and applicability to product, rationale (if not applicable), applied standard (applicable only for ‘MDR-Annex I Checklist’ tab), objective evidence from existing documents, level of compliance, gaps (if any), proposed mitigation, and remarks.

For each parameter in the GUI 400, there is a corresponding description explaining what the parameter means. For instance, for the parameter “Clause/Section” the corresponding description may be “Clause/Section reference from EN 62366-1:2015+A1:2020 standard and EU MDR 2017/745 Regulation.” Similarly, for the parameter “Requirements”, the corresponding description may be “EN 623661-1:2015+A1:2020 Standard text and EU MDR 2017/745 Regulation text.”. Further, for the parameter “Input Type”, the corresponding description may be “The standard text is categorized as requirement or information, or compliance assessment means based on standard text interpretation”. The parameter values for data validation under this category may be “Requirement”, “Information”, and “Compliance Assessment Means”.

Further, for the parameter “Requirement Category”, the corresponding description may be “The standard text categorized as requirement input type is further categorized as process or product specific requirement based on standard requirements statement interpretation. For process specific requirement category, the objective evidence for compliance is evaluated within company QMS documentation. For product specific requirement category, the objective evidence for compliance is evaluated within product specific documentation.” Also, the parameter values for data validation under this category may be “Process”, “Product”, and “N/A” Further, for the parameter “Applicability of Usability Engineering”, the corresponding description may be “The need for applicability of Usability Engineering Process and/or availability of Usability Engineering File to ensure compliance to the relevant requirements statement of MDR Annex I and MDR Annex II is identified based on requirements statement interpretation.” Further, for the parameter “Applicability to Product”, the corresponding description may be “Update whether the requirement statement is applicable to the product or not.”, and so on.

As will be appreciated by those skilled in the art, the techniques described in the various embodiments discussed above are not routine, or conventional, or well understood in the art. The techniques discussed above provide for determining approach and scope of HF evaluation for medical devices. The techniques first receive input information related to a medical device, wherein the input information comprises product launch information, change history file, human factors evaluation documentation of the medical device and similar devices. The techniques may then extract the product launch information from the input information. The techniques may further analyse the change history file to identify one or more changes in medical device interface and medical device usability. The techniques may further classify each of the one or more versions of the medical device as one of a legacy device or a new device based on the extracted product launch information and the change history file analysis. Subsequently, the techniques may identify a base version for documentation and subsequent versions till date for the medical device interface. Further, the techniques may determine an HF evaluation approach for each of versions of the medical device interface based on the classification, the HF evaluation documentation, and incremental documentation requirement of the subsequent versions of the medical device interface. Further, the techniques may perform a gap analysis for the base version and the subsequent version to identify documentation-related gaps. Furthermore, the techniques may determine a scope and plan corresponding to the version for HF evaluation activities based on the determined approach, and the identified documentation-related gaps.

The techniques discussed above provide various advantages, such as, by systematically determining the approach and scope of HF evaluation for medical devices in accordance with the IEC 62366 standards, the techniques simplified a complex decision-making process. The extraction of input information, including launch dates, change history, and documentation, ensures a detailed understanding of the medical devices evolution. The analysis of change impacts and classifications as legacy or new devices leads to tailored evaluation approaches for different versions. Further, conducting the gap analysis identifies areas of improvement, enhancing documentation compliance. The outcome of the disclosed techniques provide a clear scope and plan that directs HF evaluation activities, usability, safety, and alignment with regulatory requirements. Additionally, the disclosed techniques optimize medical device development timelines, enhance user experiences, and mitigate compliance-related challenges across diverse geographical markets.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

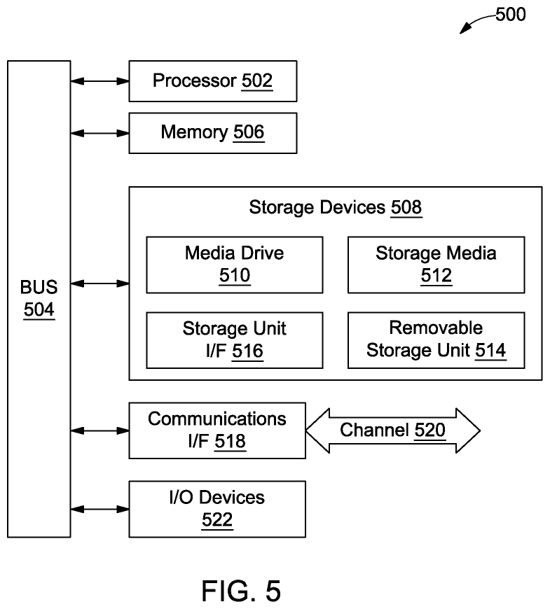

The disclosed methods and systems may be implemented on a conventional or a general-purpose computer system, such as a personal computer (PC) or server computer. Referring now to FIG. 5, an exemplary computing system 500 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 500 may represent, for example, a user device such as a desktop, a laptop, a mobile phone, personal entertainment device, DVR, and so on, or any other type of special or general-purpose computing device as may be desirable or appropriate for a given application or environment. The computing system 500 may include one or more processors, such as a processor 502 that may be implemented using a general or special purpose processing engine such as, for example, a microprocessor, microcontroller, or other control logic. In this example, the processor 502 is connected to a bus 504 or other communication medium. In some embodiments, the processor 502 may be an Artificial Intelligence (AI) processor, which may be implemented as a Tensor Processing Unit (TPU), or a graphical processor unit, or a custom programmable solution Field-Programmable Gate Array (FPGA).

The computing system 500 may also include a memory 506 (main memory), for example, Random Access Memory (RAM) or other dynamic memory, for storing information and instructions to be executed by the processor 502. The memory 506 also may be used for storing temporary variables or other intermediate information during execution of instructions to be executed by the processor 502. The computing system 500 may likewise include a read only memory (“ROM”) or other static storage device coupled to bus 504 for storing static information and instructions for the processor 502.

The computing system 500 may also include a storage device 508, which may include, for example, a media drive 510 and a removable storage interface. The media drive 510 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 512 may include, for example, a hard disk, magnetic tape, flash drive, or other fixed or removable medium that is read by and written to by the media drive 510. As these examples illustrate, the storage media 512 may include a computer-readable storage medium having stored therein particular computer software or data.

In alternative embodiments, the storage devices 508 may include other similar instrumentalities for allowing computer programs or other instructions or data to be loaded into the computing system 500. Such instrumentalities may include, for example, a removable storage unit 514 and a storage unit interface 516, such as a program cartridge and cartridge interface, a removable memory (for example, a flash memory or other removable memory module) and memory slot, and other removable storage units and interfaces that allow software and data to be transferred from the removable storage unit 514 to the computing system 500.

The computing system 500 may also include a communications interface 518. The communications interface 518 may be used to allow software and data to be transferred between the computing system 500 and external devices. Examples of the communications interface 518 may include a network interface (such as an Ethernet or other NIC card), a communications port (such as for example, a USB port, a micro-USB port), Near field Communication (NFC), etc. Software and data transferred via the communications interface 518 are in the form of signals which may be electronic, electromagnetic, optical, or other signals capable of being received by the communications interface 518. These signals are provided to the communications interface 518 via a channel 520. The channel 520 may carry signals and may be implemented using a wireless medium, wire or cable, fiber optics, or other communications medium. Some examples of the channel 520 may include a phone line, a cellular phone link, an RF link, a Bluetooth link, a network interface, a local or wide area network, and other communications channels.

The computing system 500 may further include Input/Output (I/O) devices 522. Examples may include, but are not limited to a display, keypad, microphone, audio speakers, vibrating motor, LED lights, etc. The I/O devices 522 may receive input from a user and also display an output of the computation performed by the processor 502. In this document, the terms “computer program product” and “computer-readable medium” may be used generally to refer to media such as, for example, the memory 506, the storage devices 508, the removable storage unit 514, or signal(s) on the channel 520. These and other forms of computer-readable media may be involved in providing one or more sequences of one or more instructions to the processor 502 for execution. Such instructions, generally referred to as “computer program code” (which may be grouped in the form of computer programs or other groupings), when executed, enable the computing system 500 to perform features or functions of embodiments of the present invention.

In an embodiment where the elements are implemented using software, the software may be stored in a computer-readable medium and loaded into the computing system 500 using, for example, the removable storage unit 514, the media drive 510 or the communications interface 518. The control logic (in this example, software instructions or computer program code), when executed by the processor 502, causes the processor 502 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

It is intended that the disclosure and examples be considered as exemplary only, with a true scope and spirit of disclosed embodiments being indicated by the following claims.

What is claimed is:

1. A method for determining approach and scope of human factors (HF) evaluation for medical devices, the method comprising:
receiving, by a computing device, input information related to a medical device via a Graphical User Interface (GUI), wherein the input information comprises product launch information, change history file, human factors evaluation documentation of the medical device and similar devices;
extracting, by the computing device, the product launch information from the input information;
analysing, by the computing device, the change history file to identify one or more changes in medical device interface and medical device usability;
classifying, by the computing device, each of the one or more versions of the medical device as one of a legacy device or a new device based on the extracted product launch information and the change history file analysis;
identifying, by the computing device, a base version for documentation and subsequent versions till date for the medical device interface;
determining, by the computing device, an HF evaluation approach for each of versions of the medical device interface based on the classification, the HF evaluation documentation, and incremental documentation requirement of the subsequent versions of the medical device interface;
performing, by the computing device, a gap analysis for the base version and the subsequent version to identify documentation-related gaps; and
determining, by the computing device, a scope and plan corresponding to the version for HF evaluation activities based on the determined approach, and the identified documentation-related gaps.

2. The method of claim 1, wherein the product launch information comprises information corresponding to one or more versions of the medical device, and a launch date and change information of each of the one or more versions.

3. The method of claim 2, wherein:
when the launch date of a version of the medical device is prior to the predefined date the medical device is classified as the legacy device, wherein the predefined date is as per a set of medical device regulatory standards for human factors and usability, and
when the launch date of the version of the medical device is after the predefined date the medical device is classified as the new device.

4. The method of claim 1, wherein the change history file comprises impact of change information anticipated for an interface of the medical device.

5. The method of claim 1, further comprising identifying the base version of the medical device.

6. The method of claim 1, further comprising rendering the scope and plan corresponding to the version to the computing device through the GUI.

7. A Graphical User Interface (GUI) client on a computing device for determining approach and scope of human factors (HF) evaluation for medical devices, the GUI client is configured to:
receive input information related to a medical device, wherein the input information comprises product launch information;
render a change history file based on the product launch information;
receive HF evaluation documentation of a base version of the medical device; and
for each version from the base version to latest version of the medical device, render the scope and plan corresponding to the version to the computing device.

8. A system for determining approach and scope of human factors (HF) evaluation for medical devices, the system comprising:
a processor; and
a memory communicatively coupled to the processor, wherein the memory stores processor instructions, which when executed by the processor, cause the processor to:
receive input information related to a medical device via a Graphical User Interface (GUI), wherein the input information comprises product launch information, change history file, human factors evaluation documentation of the medical device and similar devices;
extract the product launch information from the input information;
analyse the change history file to identify one or more changes in medical device interface and medical device usability;
classify each of the one or more versions of the medical device as one of a legacy device or a new device based on the extracted product launch information and the change history file analysis;
identify a base version for documentation and subsequent versions till date for the medical device interface;
determine an HF evaluation approach for each of versions of the medical device interface based on the classification, the HF evaluation documentation, and incremental documentation requirement of the subsequent versions of the medical device interface;
perform a gap analysis for the base version and the subsequent version to identify documentation-related gaps; and
determine a scope and plan corresponding to the version for HF evaluation activities based on the determined approach, and the identified documentation-related gaps.

9. The system of claim 8, wherein the product launch information comprises information corresponding to one or more versions of the medical device, and a launch date and change information of each of the one or more versions.

10. The system of claim 9, wherein:
when the launch date of a version of the medical device is prior to the predefined date the medical device is classified as the legacy device, wherein the predefined date is as per a set of medical device regulatory standards for human factors and usability, and
when the launch date of the version of the medical device is after the predefined date the medical device is classified as the new device.

11. The system of claim 8, wherein the change history file comprises impact of change information anticipated for an interface of the medical device.

12. The system of claim 8, wherein the processor instructions, when executed by the processor, further cause the processor to identify the base version of the medical device.

13. The system of claim 8, wherein the processor instructions, when executed by the processor, further cause the processor to render the scope and plan corresponding to the version to the computing device through the GUI.
